(19) United States
(12) Patent Application Publication
(10) Pub. No.: US 2025/0030371 A1
(43) Pub. Date: Jan. 23, 2025

(54) Motor Control Apparatus, Motor Drive Apparatus, and Device Using Same

(71) Applicant: Hitachi, Ltd., Chiyoda-ku, Tokyo (JP)

(72) Inventors: Yasuo NOTOHARA, Tokyo (JP); Agnes HADINATA, Tokyo (JP); Dongsheng LI, Tokyo (JP); Takahiro SUZUKI, Tokyo (JP)

(21) Appl. No.: 18/274,153

(22) PCT Filed: Dec. 28, 2021
(86) PCT No.: PCT/JP2021/048765

§ 371 Date: Jul. 25, 2023

(30) Foreign Application Priority Data
Feb. 17, 2021 (JP) 2021-023440

(51) Int. Cl. H02P 27/12; B60L 15/00

(52) U.S. Cl. CPC H02P 27/12; B60L 15/007

(57) ABSTRACT

Disclosed are a motor control apparatus, a motor drive apparatus and a device that uses the same, with which, even if the electrical angular frequency is high, it is possible to detect a motor current fundamental wave component with high accuracy and to perform drive control on a motor in a stable manner. On the basis of a speed command (ω*) and a detected value (Iuvw) for motor current, this motor control apparatus creates a control signal (PWM) for controlling a motor (4) and comprises: a phase current detection means which detects the phase current of the motor; and a fundamental wave component extraction means (5) which extracts a fundamental wave component for the motor phase current detected by the phase current detection means. The fundamental wave component extracted by the fundamental wave component means is used as the detected value for motor current to create the control signal.

### TECHNICAL FIELD

The present invention relates to a motor control apparatus that controls an AC motor, a motor drive apparatus that drives the AC motor at a variable speed, and a device using the motor drive apparatus.

### BACKGROUND ART

In various fields such as general industries, home electric appliances, and automobiles, further high-speed rotation of motors has been advanced for the purpose of miniaturization and high output.

Synchronous PWM control (for example, see PTL 1) that changes a PWM carrier frequency and the number of pulses for each electrical angular frequency is used for high-speed rotation control of the motor.

A DC bus current detection method (for example, see PTLs 2 and 3) for detecting a three-phase AC current without using a phase current sensor is used for detecting a motor current.

Simple vector control (for example, see PTL 4) in which a current controller is omitted is used for high-speed rotation control of a permanent magnet synchronous motor.

### CITATION LIST

### Patent Literature

PTL 1: JP 2005-237194 A
PTL 2: JP 8-19263 A
PTL 3: JP 6129972 B2
PTL 4: JP 2004-48868 A

### SUMMARY OF INVENTION

### Technical Problem

In the synchronous PWM control described in PTL 1, the PWM carrier frequency changes in synchronization with the electrical angle rotation frequency, and the number of PWM pulses is controlled to be a multiple of three (odd number) and one pulse. In other words, at the time of high-speed rotation, the number of PWM pulses decreases to a maximum of one.

When the number of PWM pulses decreases, a fluctuation range of the motor current increases, and current detection by a DC bus current detection method described later becomes difficult.

In the DC bus current detection method, the DC bus current detected almost simultaneously according to the combinations of the PWM pulses is distributed to each combination to reproduce a fundamental wave component of the motor current, but the simultaneity of the detection of the DC bus current changes depending on the detection capability of an AD converter of a microcomputer (hereinafter, referred to as a microcomputer) as a controller. In other words, the simultaneity of the DC bus current cannot be secured at the time of high-speed rotation, and the reproduction error of the motor current increases.

In this regard, the present invention provides a motor control apparatus, a motor drive apparatus, and a device using the same, which are capable of detecting a motor current fundamental wave component with high accuracy and stably controlling driving of a motor even in a case where an electrical angular frequency is high as in high-speed driving.

### Solution to Problem

In order to solve the above problem, a motor control apparatus according to the present invention creates a control signal for controlling a motor on the basis of a speed command and a detected value of a motor current. The motor control apparatus includes: a phase current detection means that detects a phase current of the motor; and a fundamental wave component extraction means that extracts a fundamental wave component of the phase current of the motor detected by the phase current detection means. The control signal is created by using, as the detected value of the motor current, the fundamental wave component extracted by the fundamental wave component extraction means.

In order to solve the above problems, a motor drive apparatus according to the present invention includes: an inverter that drives and control a motor; and a control unit that creates a control signal for controlling the inverter. The control unit is the motor control apparatus according to the present invention.

In order to solve the above problems, a device according to the present invention is driven by a motor. The motor is driven by the motor drive apparatus according to the present invention.

### Advantageous Effects of Invention

According to the present invention, the motor current fundamental wave component can be detected with high accuracy even in a case where the electrical angular frequency is high.

### BRIEF DESCRIPTION OF DRAWINGS

FIG. 1 is a functional block diagram illustrating a configuration of a motor drive apparatus according to a first embodiment.

FIG. 2 is a waveform diagram illustrating waveforms of a line voltage and a motor phase current output from an inverter 3.

FIG. 3 is a circuit diagram illustrating a current flowing through a main circuit unit of the inverter 3.

FIG. 4 is a waveform diagram illustrating operation waveforms of the motor drive apparatus (the inverter 3 and a control apparatus unit).

FIG. 5 is a functional block diagram illustrating an example of a motor current calculator that calculates a motor current from a detected value of a DC bus current.

FIG. 6 is a waveform diagram illustrating operation waveforms of the motor drive apparatus at the time of high-speed rotation of the motor.

FIG. 7 illustrates a relationship between a rotational speed and a phase difference in a case where a motor is a 4-pole PMSM and the detection interval of an AD converter is 10 μs.

FIG. 8 is a functional block diagram illustrating a configuration of a DC bus motor current detector 5 in the first embodiment.

FIG. 9 is a functional block diagram illustrating a configuration of a fundamental wave component extractor 5B to which simple Fourier transform is applied.

FIG. 10 is a functional block diagram illustrating a configuration of the fundamental wave component extractor 5B to which a sine wave transfer function is applied.

FIG. 11 is a waveform diagram illustrating a motor phase current detected by the DC bus current and a fundamental wave component of the motor current extracted from the motor phase current.

FIG. 12 is a waveform diagram illustrating a waveform of a motor current of a rotationally-driven motor 4 and a waveform of a DC bus current in the first embodiment.

FIG. 13 is an external view illustrating a schematic configuration of a stick-type cleaner.

FIG. 14 is an external view illustrating a schematic configuration of drum-type washing machine.

FIG. 15 is an external view illustrating a schematic configuration of an electric vehicle.

FIG. 16 is a configuration diagram illustrating a schematic configuration of a hybrid turbocharger.

FIG. 17 is a functional block diagram illustrating a configuration of a motor drive apparatus according to a second embodiment.

FIG. 18 is a functional block diagram illustrating a configuration of a motor drive apparatus according to a third embodiment.

### DESCRIPTION OF EMBODIMENTS

Hereinafter, embodiments of the present invention will be described according to first to third embodiments below with reference to the drawings.

In each drawing, the same reference numerals indicate the same constituent elements or constituent elements having similar functions.

### First Embodiment

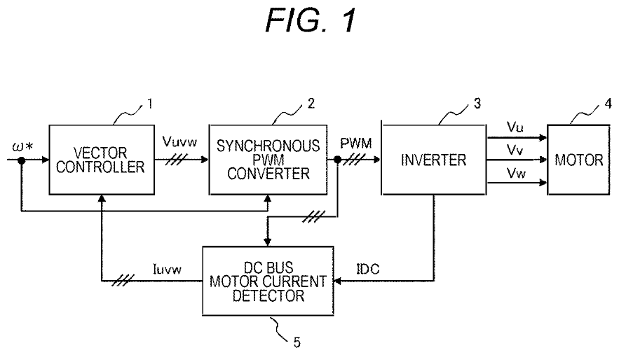

A first embodiment will be described with reference to FIGS. 1 to 16.

FIG. 1 is a functional block diagram illustrating a configuration of a motor drive apparatus according to the first embodiment of the present invention.

As illustrated in FIG. 1, the motor drive apparatus of the first embodiment includes an inverter 3 that applies three-phase AC voltages Vu, Vv, and Vw to a motor 4. In the first embodiment, a permanent magnet synchronous motor (hereinafter, referred to as “PMSM”) is applied as the motor 4.

The inverter 3 includes an inverter circuit such as a three-phase bridge circuit including a power semiconductor switching element (for example, an IGBT or a power MOSFET). The inverter circuit turns on and off the semiconductor switching element to convert an input DC voltage from a DC power supply into a three-phase AC voltage, and outputs the three-phase AC voltage to the motor 4.

A control apparatus unit that controls on/off of the semiconductor switching element configuring the inverter circuit includes a synchronous PWM converter 2 that creates a pulse width modulation (hereinafter, referred to as “PWM”) control signal, a vector controller 1 that creates a three-phase voltage command Vuvw on the basis of a speed command ω* and a three-phase motor current Iuvw and gives the Vuvw to the synchronous PWM converter 2, and a DC bus motor current detector 5 that detects a DC bus current IDC in the inverter 3, and reproduces the Iuvw from a detected value of the IDC.

In the vector controller 1, simple vector control (see PTL 4) without using a current controller is applied. In the simple vector control, a first-order lag filter value of a q-axis current Iq, which is a q-axis component in the rotation coordinate system of the motor current, is set as a q-axis current command Iq* (Iq*=(1/(1+T·s))Iq: T is a time constant). Note that a d-axis current command Id*, which is a current command of a d-axis component in the rotation coordinate system of the motor current, is set to zero.

The vector controller 1 calculates a d-axis voltage command Vd* and a q-axis voltage command Vq* on the basis of a rotational speed command ωᵣ* and the above-described Iq* and Id* by using a voltage equation expressed by Equation (1).

$$\\ \begin{matrix}[ Mathematical Formula 1 ] & \\ [ \begin{matrix}{V}_{d}^{{}_{} *} \\ {V}_{q}^{{}_{} *}\end{matrix} ] = R [ \begin{matrix}{I}_{d}^{{}_{} *} \\ {I}_{q}^{{}_{} *}\end{matrix} ] + {ω}_{r}^{{}_{} *} [ \begin{matrix}- {L}_{q} {I}_{q}^{{}_{} *} \\ {L}_{d} {I}_{d}^{{}_{} *}\end{matrix} ] + [ \begin{matrix}0 \\ {K}_{e} {ω}_{r}^{{}_{} *}\end{matrix} ] & ( 1 )\end{matrix}$$

In Equation (1), R, Lq, Ld, and Ke are a winding resistance, a q-axis inductance, a d-axis inductance, and an induced voltage constant, respectively.

The vector controller 1 creates three-phase voltage command Vuvw from Vd* and Vq* by dq/three-phase conversion.

Therefore, in the first embodiment, the vector control can be performed without any current feedback control system by detecting the fundamental wave component of the motor current.

In the synchronous PWM converter 2, the cycle of the carrier wave signal and the cycle of the sine wave command signal (modulated wave signal) have a relation of integer multiple, and so-called synchronous PWM control for synchronizing the phases of both signals is applied (see PTL 1).

In the synchronous PWM control, generally, a carrier frequency is changed according to a change in the output frequency of the inverter. In addition, in the synchronous PWM control, in many cases, the number of pulses in one cycle of the PWM control signal is constant regardless of the inverter output frequency, but the number of pulses may be switched according to the inverter output frequency. In the synchronous PWM converter 2 according to the first embodiment, the number of PWM pulses and the carrier frequency are set for each electrical angular frequency on the basis of the three-phase voltage command Vuvw and the rotational speed command ωᵣ*, and a PWM control signal (upper arm) is created according to the carrier frequency set to Vuvw.

As described above, the inverter 3 is a DC/AC converter including a semiconductor switching element, and outputs a three-phase AC voltage (Vu, Vv, Vw) as a PWM pulse on the basis of a PWM control signal (upper arm) output from the synchronous PWM converter 2. The motor 4 is driven by the PWM pulse. Note that the PWM control signal may be provided to the semiconductor switching element via a driver circuit.

The inverter 3 includes a shunt resistor that detects a DC bus current. The voltage between the terminals of the shunt resistor is input to the DC bus motor current detector 5 as a detected value IDC of the DC bus current.

The DC bus motor current detector 5 extracts the fundamental wave component Iuvw of the motor current on the basis of the detected value IDC of the DC bus current and the PWM control signal (upper arm), and outputs the extracted Iuvw to the vector controller 1.

Hereinafter, the operation of the DC bus motor current detector 5 and the configuration of the DC bus motor current detector 5 will be described.

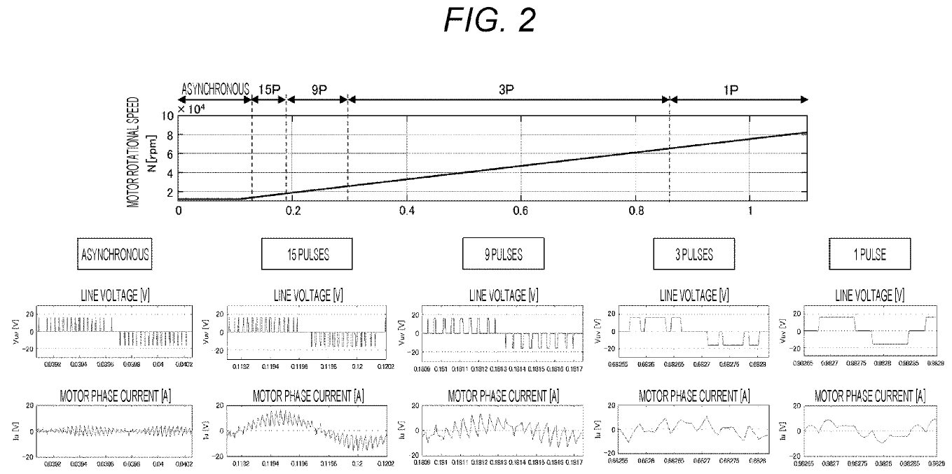

First, an operation common to the conventional DC bus current detection method (see PTLs 2 and 3) in the operation of the DC bus motor current detector 5 will be described with reference to FIGS. 2 to 7.

FIG. 2 is a waveform diagram illustrating waveforms of a line voltage and a motor phase current output from the inverter 3.

Note that as illustrated in the upper diagram of FIG. 2, the rotational speed of the motor 4 is accelerated from 0 rpm to 100,000 rpm. The vector controller 1 creates the PWM control signal by the asynchronous PWM control at the time of low speed, but after switching to the synchronous PWM control, as the rotational speed increases, the number of pulses of the PWM control signal per half cycle of the voltage command is gradually decreased from fifteen to one.

As illustrated in FIG. 2, as the rotational speed of the motor 4 increases, the number of PWM pulses of the line voltage decreases, and when the rotational speed exceeds 60,000 rpm, one pulse is generated per electrical angle half cycle. At this time, since the number of PWM pulses decreases, the ripple of the motor phase current increases, and when the number of PWM pulses is three or less, the magnitude of the fundamental wave component becomes unclear from the waveform of the motor current. For this reason, only with the conventional DC bus current detection method, it is difficult to detect the fundamental wave component of the motor current with desired accuracy at the time of high-speed rotation of the motor 4, and the control of the motor 4 may become unstable. Therefore, a current detection method for detecting, from such a motor current, the fundamental wave component of the motor current is desired.

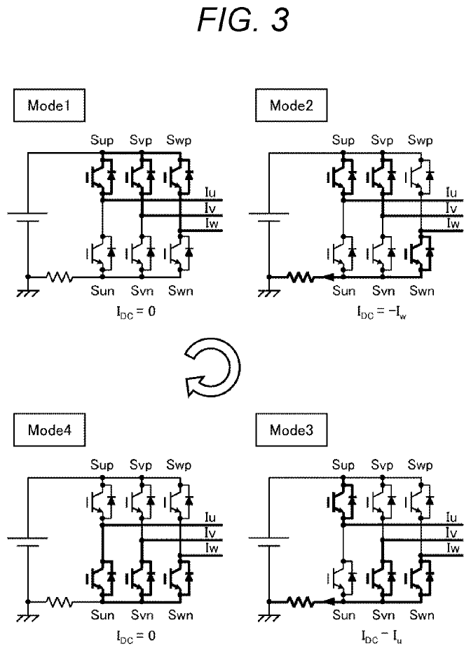

FIG. 3 is a circuit diagram illustrating a current flowing through a main circuit unit of the inverter 3.

In each operation mode (Modes 1 to 4) of the semiconductor switching element (IGBT in FIG. 3), a circuit portion through which a current flows is indicated by a thick line.

In a case where all the semiconductor switching elements Sup, Svp, and Swp of the upper arm are ON as in Mode 1 and a case where all the semiconductor switching elements Sun, Svn, and Swn of the lower arm are ON as in Mode 4, the motor current does not flow through the shunt resistor (IDC=0).

In a case where the semiconductor switching elements Sup and Svp of the upper arm and the semiconductor switching element Swn of the lower arm are ON as in Mode 2 and a case where the semiconductor switching element Sup of the upper arm and the semiconductor switching elements Svn and Swn of the lower arm are ON as in Mode 3, the motor current flows through the shunt resistor (IDC=−Iw (Mode 2), IDC=Iu (Mode 3)).

Therefore, the motor current can be detected by detecting the DC bus current flowing through the shunt resistor in the operation mode in which the motor current flows through the shunt resistor.

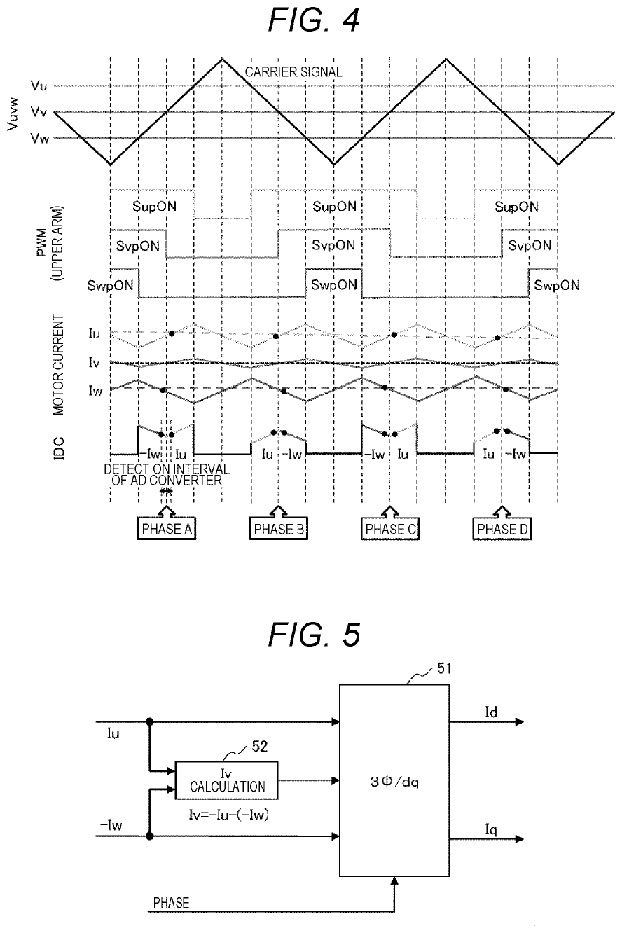

Here, means for detecting the motor current from the DC bus current detected value IDC will be described with reference to FIG. 4.

FIG. 4 is a waveform diagram illustrating operation waveforms of the motor drive apparatus (the inverter 3 and the control apparatus unit).

In FIG. 4, the waveforms of the carrier wave signal and the three-phase voltage command Vuvw (modulated wave signal), the waveform of the PWM control signal (upper arm) created on the basis of the carrier signal and the three-phase voltage command Vuvw, the waveforms of three phases of motor currents Iu, Iv, and Iw, and the waveform of the DC bus current IDC are illustrated in order from the top.

In FIG. 4, a point described in each waveform of the motor currents Iu and Iw and the DC bus current IDC indicates a timing at which the DC bus motor current detector 5 in the control apparatus unit of the inverter 3 detects the DC bus current. This detection timing corresponds to, for example, an activation timing of the A/D conversion function included in the microcomputer configuring the control apparatus unit.

The detection timing of the DC bus current is timing before and after the timing at which the PWM control signal (pulse) of the intermediate phase in the three-phase applied voltage command Vuvw (modulated wave signal) changes. In FIG. 4, the detection timing is timing before and after the timing at which the V-phase PWM control signal changes.

At the timing before and after the PWM control pulse of the intermediate phase changes, as in Modes 2 and 3 in FIG. 3 described above, in one and the other of the upper arm and the lower arm, the semiconductor switching element of one phase and the semiconductor switching element of the other two phases among the three phases are turned on. Therefore, at each timing, the motor current of different one phase among the three phases is detected. That is, the DC bus motor current detector 5 detects motor currents of two phases although detection timings are different.

As illustrated in FIG. 4, the motor currents (−Iw, Iu) of two phases are detected at timings before and after a phase A by the IDC, and the motor currents (Iu, Iv, Iw) of three phases are calculated with reference to the phase A on the basis of −Iw and Iu. Further, the motor currents (Iu, −Iw) of two phases are detected at timings before and after a phase B by the IDC, and the motor currents (Iu, Iv, Iw) of three phases are calculated with reference to the phase B on the basis of Iu and −Iw.

Note that the operation modes of the inverter 3 at the timings before and after the phase A correspond to Mode 2 (SupON, SvpON, SwnON(SwpOFF)) and Mode 3 (SupON, SvnON(SvpOFF), SwnON(SwpOFF)) in FIG. 2, respectively.

The detection of the IDC at the timing before and after the timing at which the PWM control signal changes is repeated to connect detected values, whereby the three-phase motor current is detected. Further, in a case where the motor speed is medium or low (the number of pulses>3: see FIG. 2), the fundamental wave component of the motor current is detected.

Note that as described above, two phases of the three-phase motor current are detected by the IDC, and the remaining one phase is calculated from the detected two phases as described below.

FIG. 5 is a functional block diagram illustrating an example of a motor current calculator that calculates the motor current from the detected value of the DC bus current. Note that the present calculator is based on the related art, but is partially applied to the first embodiment.

In the motor current calculator, from the motor currents of two phases (the U phase and the W phase in FIG. 5) detected by the IDC, the remaining one phase (the V phase in FIG. 5) is calculated by a phase current calculator (a V-phase current (Iv) calculator 52 in FIG. 5) by using a relationship of “Iu+Iv+Iw=0”.

Such a phase current calculator is also applied to the first embodiment.

Note that in FIG. 5, a three-phase/dq converter 51 included in the vector controller 1 is also illustrated. In the related art, a three-phase motor current detected value according to the IDC is directly input to the three-phase/dq converter 51. The first embodiment will be described later.

Here, when the fluctuation component of the motor current is large as in the high-speed rotation of the motor, the detected value of the DC bus current also greatly fluctuates. For this reason, in the related art (see PTL 2), the fluctuation component of the motor current is detected depending on the detection timing of the DC bus current, and the detection accuracy of the motor current is lowered.

As the related art, there is also a technique of canceling the fluctuation component of the motor current by manipulating the PWM control signal (see PTL 3) to average the detected values of the DC bus current in two consecutive periods (cycles) of the carrier wave signal. However, in a period A and a period B, the averaging of the detected values is effective when the change in electrical angle phase is small, but when the change becomes large, it is difficult to cancel the fluctuation component of the motor current even in the present technology.

Therefore, in the related art, it is difficult to accurately detect the fundamental wave component of the motor current when the electrical angle phase greatly changes during one cycle of the carrier frequency as at the time of high-speed rotation of the motor.

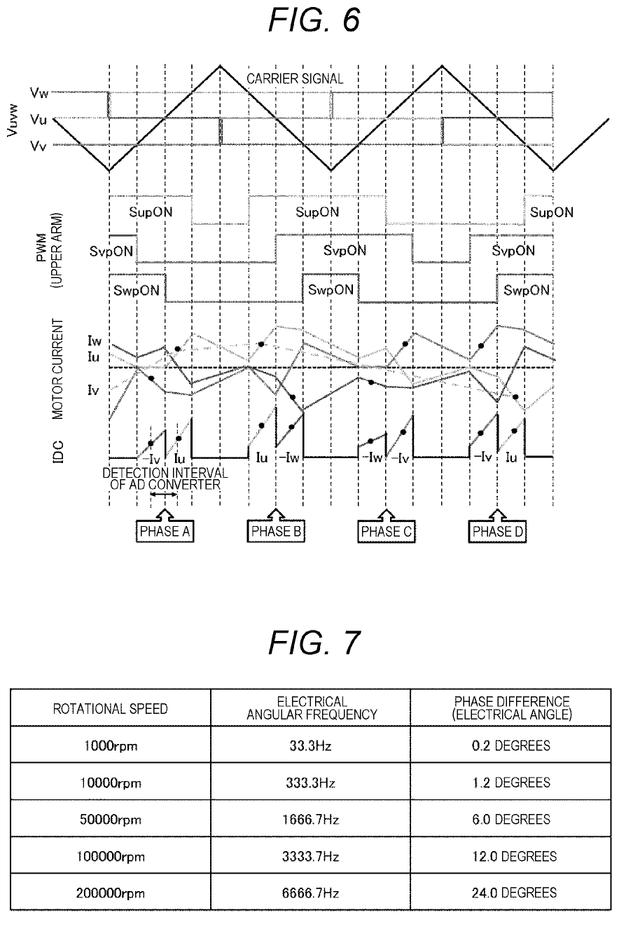

In FIG. 4, the rotational speed of the motor is medium or low, and thus in a case where the change of the three-phase voltage command Vuvw (modulated wave signal) is gentle, and the magnitude of the Vuvw detection is substantially constant during the period in which the DC bus current flows, even when the two-phase motor current is detected at different timings, an error from a case where the motor currents of two phases are detected at the same timing is small. On the other hand, as described below with reference to FIG. 6, the error increases at the time of high-speed rotation of the motor.

FIG. 6 is a waveform diagram illustrating operation waveforms of the motor drive apparatus at the time of high-speed rotation of the motor (a rotational speed at which the number of pulses in FIG. 2 is three).

Similarly to FIG. 4, in the waveform diagram in FIG. 6, the waveforms of the carrier wave signal and the three-phase voltage command Vuvw (modulated wave signal), the waveform of the PWM control signal (upper arm) created on the basis of the carrier wave signal and the three-phase voltage command Vuvw, and the waveforms of three phases of motor currents Iu, Iv, and Iw, and the DC bus current IDC are illustrated in order from the top.

Similarly to FIG. 4, in FIG. 6, a point described in each waveform of the motor currents Iu and Iw and the DC bus current IDC indicates a timing at which the DC bus motor current detector 5 in the control apparatus unit of the inverter 3 detects the DC bus current. This detection timing corresponds to, for example, an activation timing of the A/D conversion function included in the microcomputer configuring the control apparatus unit.

As illustrated in FIG. 6, the motor currents of two phases are detected by the IDC even at the time of high-speed rotation. However, the combinations (for example, in the phase A, the V phase and the U phase) of the phases of the detected motor current are all different in the phases A, B, and C. In addition, when the detection interval of the AD converter is shortened in order to improve the simultaneity of the detection by bringing the detection timings of the motor currents of two phases close to each other, the peak value and the bottom value of the motor current of each phase are detected, so that it is difficult to detect the fundamental wave component of the motor current.

As illustrated in FIG. 6, when the detection interval of the AD converter is set such that the motor current is detected near the center of each period in which the IDC flows before and after each phase, the simultaneity of the detection timings of the motor currents of two phases is impaired. For this reason, the detection accuracy of the motor current decreases, and the stability of the motor control decreases. In particular, in the simple vector control in which the current controller is not provided and the current command is calculated from the motor current detected value as in the first embodiment, the high-speed rotation control of the motor becomes difficult.

Here, the relationship between the motor rotational speed and a phase difference of the current detection timing of the motor currents of two phases according to the IDC, which has been studied by the present inventors, will be described.

FIG. 7 illustrates the relationship between the rotational speed and the phase difference in a case where the motor is a 4-pole PMSM and the detection interval of the AD converter is 10 μs. Note that the electrical angular frequency of the voltage command corresponding to the rotational speed, that is, the electrical angular frequency of the inverter output voltage is illustrated.

As illustrated in FIG. 7, the phase difference is 10 degrees or more in electrical angle at 100,000 rotations or more. This phase difference impairs the simultaneity of the detection timings of the motor currents of two phases. Therefore, the detection accuracy of the motor current decreases at 100,000 rotations or more.

As described above, in the related art in which the motor current is detected by the DC bus current, when the rotational speed of the motor becomes high, it becomes difficult to detect the fundamental wave component of the motor current, and it becomes difficult to stably control the motor.

On the other hand, according to the first embodiment, as described below, the motor current can be detected by the DC bus current even at the time of high-speed rotation.

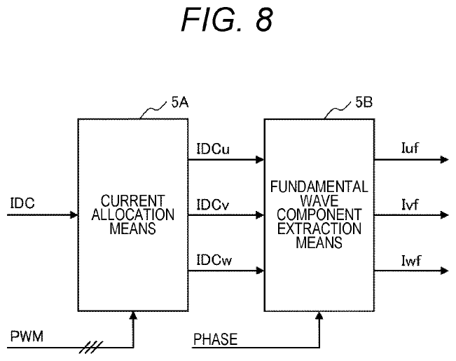

FIG. 8 is a functional block diagram illustrating a configuration of the DC bus motor current detector 5 (FIG. 1) in the first embodiment.

As illustrated in FIG. 8, the DC bus motor current detector 5 (FIG. 1) includes a current allocator 5A that inputs the voltage between the terminals of the shunt resistor as the DC bus current detected value IDC, and allocates the IDC into the motor phase currents (IDCu, IDCv, IDCw) of three phases on the basis of the PWM control signal, and a fundamental wave component extractor 5B that extracts fundamental wave components (Iuf, Ivf, Iwf) from the allocated motor phase currents (IDCu, IDCv, IDCw) of three phases, respectively.

The current allocator 5A performs current allocation according to the above-described related art. That is, the current allocator 5A allocates the IDC such that the motor currents of two phases, which are detected by the detected values of the IDC at the timings before and after the timing at which the PWM control signal of an intermediate layer changes, and the remaining motor current of one phase, which is calculated by the phase current calculator (“52” in FIG. 5) from the motor currents of two phases, are set as the motor phase currents of the corresponding phases in the motor phase currents (IDCu, IDCv, IDCw) of three phases.

Therefore, the allocated motor phase currents (IDCu, IDCv, IDCw) of three phases correspond to the motor currents of three phases detected by the above-described related art.

By using simple Fourier transform or a sine wave transfer function, the fundamental wave component extractor 5B extracts the fundamental wave components Iuf, Ivf, and Iwf from the motor phase currents IDCu, IDCv, and IDCw, respectively.

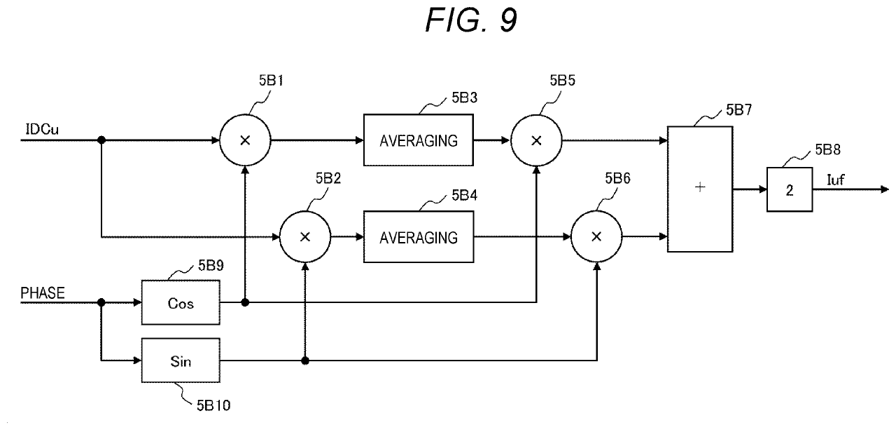

FIG. 9 is a functional block diagram illustrating a configuration of the fundamental wave component extractor 5B (FIG. 8) to which the simple Fourier transform is applied. Note that in FIG. 9, for the sake of convenience, only the configuration for extracting Iuf from IDCu is illustrated for the U phase, but the same configuration is applied to the V phase and the W phase.

As illustrated in FIG. 9, the fundamental wave component extractor 5B (FIG. 8) includes a cosine wave generator 5B9 that generates a cosine wave (Cos) according to the rotation phase of the motor and a sine wave generator 5B10 that generates a sine wave (Sin), a multiplier 5B1 that multiplies the input signal (IDCu) by Cos and a multiplier 5B2 that multiplies Sin, a filter 5B3 that averages the output values of the multiplier 5B1 and a filter 5B4 that averages the output values of the multiplier 5B2, a multiplier 5B5 that multiplies the output value of the filter 5B3 by Cos and a multiplier 5B6 that multiplies the output value of the filter 5B4 by Sin, an adder 5B7 that adds the output value of the multiplier 5B5 and the output value of the multiplier 5B6, and a calculator 5B8 that doubles the output value of the adder 5B7 and outputs the result as Iuf.

According to the fundamental wave component extractor illustrated in FIG. 9, the fundamental wave component, which is synchronized with the rotation phase of the motor, of the motor phase current detected from the DC bus current can be extracted. By using the fundamental wave component as the motor current detected value, the control apparatus unit (the vector controller 1, the synchronous PWM converter 2) of the motor drive apparatus of the first embodiment can perform control such that the motor can be stably operated at the time of high-speed rotation.

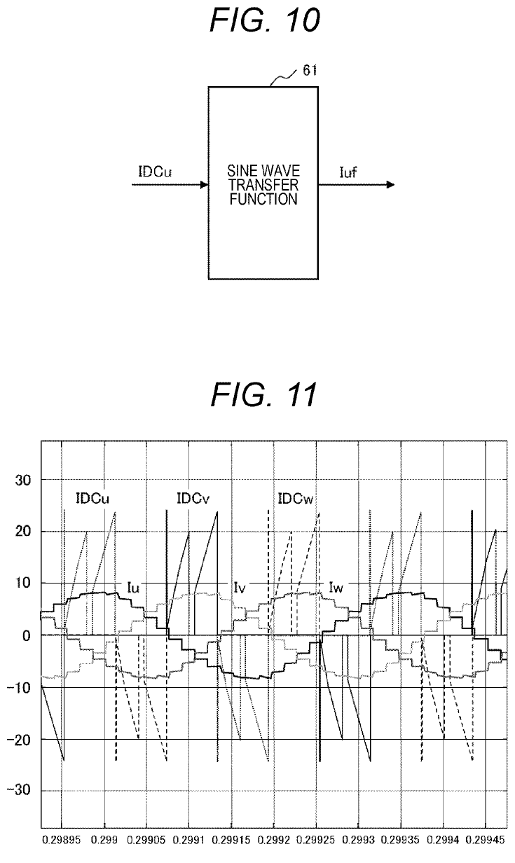

FIG. 10 is a functional block diagram illustrating a configuration of the fundamental wave component extractor 5B (FIG. 8) to which the sine wave transfer function is applied. Note that in FIG. 10, for the sake of convenience, only the configuration for extracting Iuf from IDCu is illustrated for the U phase, but the same configuration is applied to the V phase and the W phase.

An example of the sine wave transfer function is shown in Equations (2) and (3).

$$\\ \begin{matrix}[ Mathematical Formula 2 ] & \\ G ( s ) = \frac{{K}_{1} {s}^{{}_{} 2} + {K}_{2} s}{{s}^{{}_{} 2} + {K}_{3} s + {ω}_{0}^{{}_{} 2}} & ( 2 )\end{matrix}$$

In Equation (2), K₁, K₂, and K₃ are control gain constants.

$$\\ \begin{matrix}[ Mathematical Formula 3 ] & \\ G ( s ) = \frac{{K}_{4} s}{{s}^{{}_{} 2} + {K}_{5} s + {ω}_{0}^{{}_{} 2}} & ( 3 )\end{matrix}$$

In Equation (3), K₄ and K₅ are control gain constants.

The sine wave transfer function shown in Equations (2) and (3) has a gain characteristic in which the gain is maximized at the angular frequency wo. Therefore, the fundamental wave component of the motor current can be extracted by setting coo to the rotational electrical angular frequency of the motor. Note that, as long as the transfer function has such a gain characteristic, another function form may be used.

According to the fundamental wave component extractor illustrated in FIG. 10, the fundamental wave component of the motor phase current detected from the DC bus current can be extracted, similarly to the fundamental wave component extractor illustrated in FIG. 9. By using the fundamental wave component as the motor current detected value, the control apparatus unit of the motor drive apparatus of the first embodiment can perform control such that the motor can be stably operated at the time of high-speed rotation.

FIG. 11 is a waveform diagram illustrating the motor phase currents IDCu, IDCv, and IDCw (see FIG. 8) detected by the DC bus current IDC, and the fundamental wave components Iu, Iv, and Iw (corresponding to Iuf, Ivf, and Iwf in FIG. 8, respectively) of the motor current extracted from the IDCu, IDCv, and IDCw.

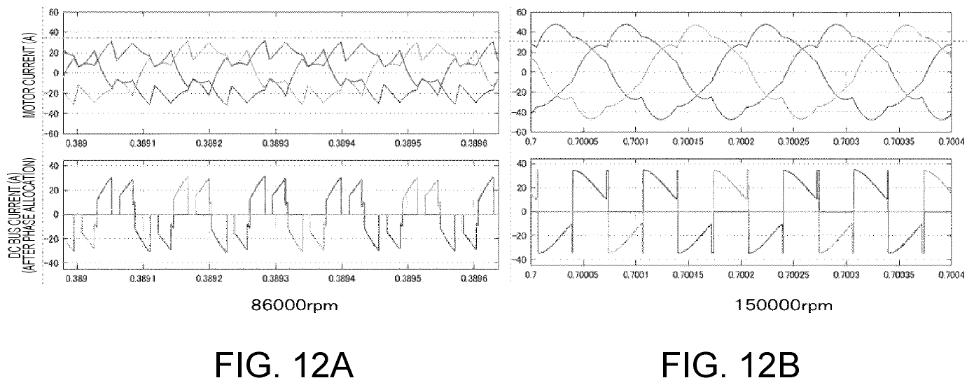

FIG. 12 is a waveform diagram illustrating the waveform of the motor current of the rotationally-driven motor 4 and the waveform of the DC bus current (after allocation to each phase by the current allocator 5A (FIG. 8)) in the first embodiment. Note that the waveforms are shown about a case where a motor rotation speed is 86,000 rpm and 150,000 rpm.

FIGS. 11 and 12 are the results of study by the present inventor through simulation. In this study, the rotational speed specification of the motor is set to 90,000 rpm. For this reason, in the case of 150,000 rpm, by the effect of so-called weak field control (Id*≠0), the waveform is formed such that the fundamental wave component can be understood.

According to the study of the present inventors as described above, according to the first embodiment, the fundamental wave component of the motor phase current can be extracted, and the motor is controlled on the basis of the extracted fundamental wave component, thereby enabling stable high-speed rotation up to one pulse drive (see FIG. 2).

Next, a cleaner, washing machine, an electric vehicle, and a hybrid charger will be described as devices using the motor drive apparatus of the first embodiment.

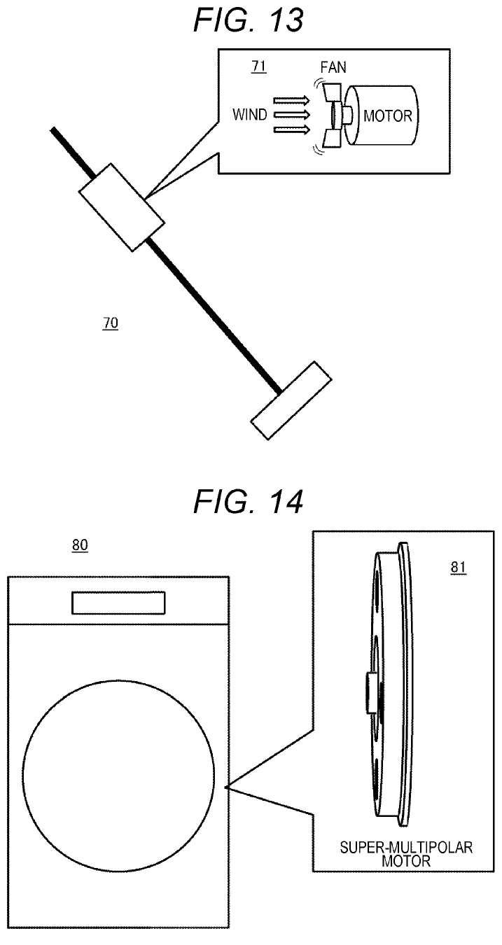

FIG. 13 is an external view illustrating a schematic configuration of a stick-type cleaner.

The cleaner 70 includes a blower 71 having a motor and a fan rotated by the motor. The motor in the blower 71 is driven by the motor drive apparatus according to the first embodiment. Therefore, since the motor can be stably rotated at a high speed, the output of the cleaner can be increased.

FIG. 14 is an external view illustrating a schematic configuration of drum-type washing machine.

The washing tub of the washing machine 80 is rotated by a super-multipolar motor 81. The super-multipolar motor 81 is driven by the motor drive apparatus according to the first embodiment. A multipolar motor such as the super-multipolar motor 81 does not rotate at a high speed as described above, but the electrical angular frequency of the inverter output voltage is high. For this reason, as in the high-speed rotation, the fluctuation of the DC bus current becomes large. Therefore, the rotation of the super-multipolar motor 81 can be stably controlled by being driven by the motor drive apparatus according to the first embodiment. For this reason, the super-multipolar motor can be applied to the washing machine to reduce vibration of the washing machine.

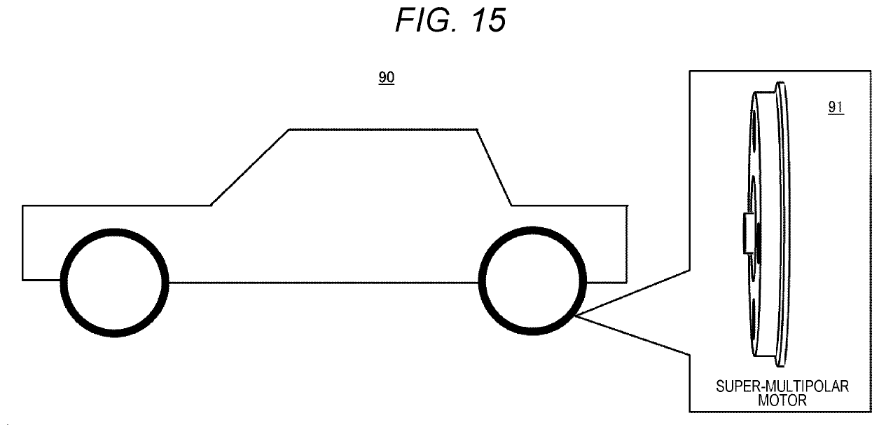

FIG. 15 is an external view illustrating a schematic configuration of an electric vehicle.

The electric vehicle 90 includes a super-multipolar motor 91 as an in-wheel motor that drives wheels. The super-multipolar motor 91 is driven by the motor drive apparatus according to the first embodiment. Therefore, similarly to the washing machine 80 (FIG. 14) described above, the vibration of the electric vehicle can be reduced.

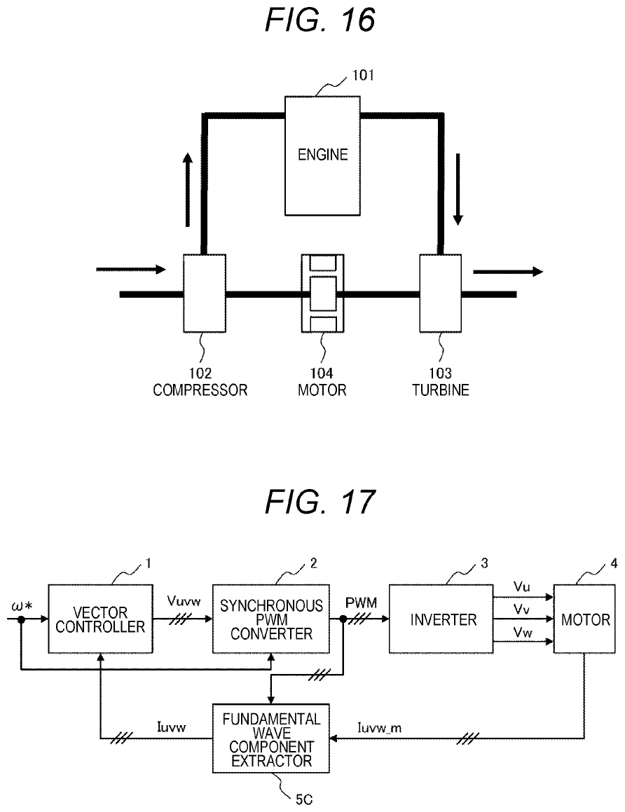

FIG. 16 is a configuration diagram illustrating a schematic configuration of a hybrid turbocharger.

As illustrated in FIG. 16, a turbine 103 rotated by exhaust of an engine 101 and a compressor 102 driven by the turbine 103 are connected via a motor 104. The motor 104 is driven by the motor drive apparatus according to the first embodiment. Therefore, since assist can be performed by the motor of the high-speed rotation specification, the responsiveness of the turbocharger is improved.

Note that the motor drive apparatus according to the first embodiment can be applied to not only the above-described device but also a device, such as a machine tool, a medical cutting instrument for dental use, or an air compressor, in which a motor is driven at a high speed or a high electrical angular frequency.

The asynchronous PWM control may be applied to the PWM converter. For example, as in a multipolar motor, the electrical angular frequency is high even when the motor is rotated at a low speed, and thus in a case where the number of PWM pulses in one cycle of the electrical angular frequency can be reduced, according to the first embodiment, the motor can be stably controlled by extracting the fundamental wave component.

As described above, according to the first embodiment, the fundamental wave component of the motor phase current detected from the DC bus current is extracted, and the motor is controlled on the basis of the fundamental wave component, so that the motor can be stably controlled even when the electrical angular frequency of the inverter output voltage is high. As a result, the rotation of the motor can be stably controlled in a case where the motor is operated at a high speed by reducing the number of PWM pulses in one cycle of the electrical angular frequency as in the synchronous PWM control or a case where the motor is operated at a low speed by increasing the electrical angular frequency as in the multipolar motor. As a result, it is possible to achieve higher performance and higher functionality of the device driven by the motor.

### Second Embodiment

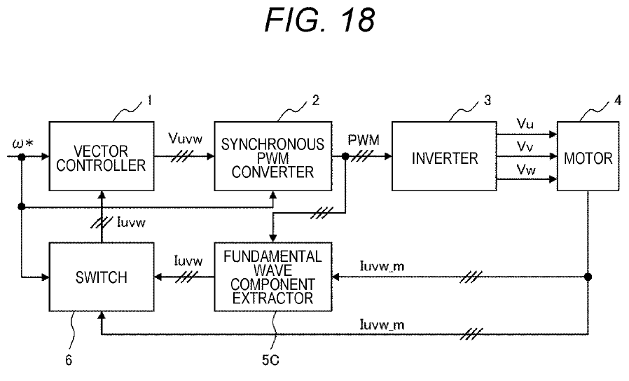

FIG. 17 is a functional block diagram illustrating a configuration of a motor drive apparatus according to a second embodiment of the invention.

Hereinafter, differences from the first embodiment will be mainly described.

In the second embodiment, the phase current flowing through the motor is detected by a phase current sensor. As the phase current sensor, for example, a current transformer (CT) provided in a three-phase output unit of the inverter 3 or a three-phase input unit of the motor 4 is applied. Note that each phase current of three phases may be detected by the phase current sensor, or two phases of three phases may be detected by a phase current sensor, and the remaining one phase may be calculated.

As illustrated in FIG. 2, the detected values Iuvw m of the three-phase motor phase currents of the motor 4 are input to a fundamental wave component extractor 5C. The fundamental wave component extractor 5C extracts the fundamental wave component of each phase current similarly to the above-described fundamental wave component extractor 5B (FIG. 8) in the first embodiment. The fundamental wave component extractor 5C outputs the extracted fundamental wave component of the three-phase motor current to the vector controller 1 as the three-phase motor current detected value Iuvw.

The fundamental wave component extractor 5C extracts the fundamental wave component (Iuvw) from the detected value Iuvw m of the motor phase current by using the simple Fourier transform (FIG. 9) and the sine wave transfer function (FIG. 10, Equations (2) and (3)), similarly to the fundamental wave component extractor 5B (FIG. 8) in the first embodiment.

According to the second embodiment, the fundamental wave component of the motor phase current detected by the phase current sensor is extracted, and the motor is controlled on the basis of the fundamental wave component, so that the motor can be stably controlled even when the electrical angular frequency of the inverter output voltage is high, similarly to the first embodiment. As a result, similarly to the first embodiment, in a case where the motor is operated at a high speed or a case where the multipolar motor is operated, the rotation of the motor can be stably controlled, so that it is possible to achieve higher performance and higher functionality of the device driven by the motor.

### Third Embodiment

FIG. 18 is a functional block diagram illustrating a configuration of a motor drive apparatus according to a third embodiment of the present invention.

Hereinafter, differences from the second embodiment will be mainly described.

The motor drive apparatus of the third embodiment includes the fundamental wave component extractor 5C similarly to the second embodiment, and further includes a switch 6 that switches the detected value of the motor current given to the vector controller 1.

According to the speed command ω*, the switch 6 selects any one of the detected value Iuvw_m of the phase current of the motor detected by the phase current sensor and the fundamental wave component of the Iuvw_m extracted by the fundamental wave component extractor 5C as in the second embodiment, and gives the selected one as the phase motor current detected value Iuvw to the vector controller 1.

The switch 6 executes vector control on the basis of the detected value Iuvw_m of the phase current of the motor detected by the phase current sensor at the time of low/medium-speed rotation that the electrical angular frequency is low, and on the basis of the fundamental wave component of the Iuvw_m at the time of high-speed rotation that the electrical angular frequency is high.

According to the third embodiment, the motor can be stably controlled in a wide speed range from an extremely low speed to an ultra-high speed.

Incidentally, this invention is not limited to the above-described embodiments, and various modifications are included. For example, the above-described embodiments have been described in detail for easy understanding of the invention and are not necessarily limited to those having all the described configurations. Further, it is possible to add, delete, and replace other configurations for a part of the configuration of each embodiment.

### REFERENCE SIGNS LIST

1 vector controller
2 synchronous PWM converter
3 inverter
4 motor
5 DC bus motor current detector
5A current allocator
5B fundamental wave component extractor
5C fundamental wave component extractor
6 switch
51 three-phase/dq converter
52 phase current calculator
70 cleaner
71 blower
80 washing machine
81 super-multipolar motor
90 electric vehicle
101 engine
102 compressor
103 turbine
104 motor

1. A motor control apparatus that creates a control signal for controlling a motor on a basis of a speed command and a detected value of a motor current, the motor control apparatus comprising:
a phase current detection means that detects a phase current of the motor; and
a fundamental wave component extraction means that extracts a fundamental wave component of the phase current of the motor detected by the phase current detection means,
wherein the control signal is created by using, as the detected value of the motor current, the fundamental wave component extracted by the fundamental wave component extraction means.

2. The motor control apparatus according to claim 1, wherein the phase current detection means detects the phase current from a detected value of a DC bus current in an inverter that drives the motor.

3. The motor control apparatus according to claim 1, wherein the phase current detection means is a phase current sensor.

4. The motor control apparatus according to claim 3, further comprising:
a switch that selects one of the phase current detected by the phase current sensor and the fundamental wave component according to the speed command,
wherein the control signal is created by using, as the detected value of the motor current, the phase current or the fundamental wave component selected by the switch.

5. The motor control apparatus according to claim 1, wherein the fundamental wave component extraction means extracts the fundamental wave component by simple Fourier transform.

6. The motor control apparatus according to claim 1, wherein the fundamental wave component extraction means extracts the fundamental wave component by a sine wave transfer function.

7. The motor control apparatus according to claim 1, wherein the control signal is a PWM signal,
the motor control apparatus further comprising:
a PWM converter that creates the PWM signal on a basis of a voltage command to be a modulated wave signal and a carrier wave; and
a controller that creates the voltage command on a basis of the speed command and the detected value of the motor current.

8. The motor control apparatus according to claim 7, wherein the PWM converter creates the PWM signal by synchronous PWM.

9. The motor control apparatus according to claim 7, wherein the controller creates the voltage command according to a current command calculated from the motor current on a basis of a voltage equation of the motor.

10. The motor control apparatus according to claim 9, wherein the controller creates the voltage command by simple vector control.

11. The motor control apparatus according to claim 1, wherein the motor is a multipolar motor.

12. A motor drive apparatus comprising:
an inverter that drives and control a motor; and
a control unit that creates a control signal for controlling the inverter,
wherein
the control unit
creates the control signal on a basis of a speed command and a detected value of a motor current, and
includes
a phase current detection means that detects a phase current of the motor, and
a fundamental wave component extraction means that extract a fundamental wave component of the phase current of the motor detected by the phase current detection means, and
the control signal is created by using, as the detected value of the motor current, the fundamental wave component extracted by the fundamental wave component extraction means.

13. A device driven by a motor, wherein the motor is driven by the motor drive apparatus according to claim 12.
